(19) United States
(12) Patent Application Publication
(10) Pub. No.: US 2017/0086284 A1
(43) Pub. Date: Mar. 23, 2017

(54) ENERGY EFFICIENT HIGH POWER PLASMA TORCH

(71) Applicant: PYROGENESIS CANADA INC., Montreal (CA)

(72) Inventors: Pierre CARABIN, Montreal (CA); Michel G. DROUET, Montreal (CA)

(21) Appl. No.: 15/311,466

(22) PCT Filed: May 19, 2015
(86) PCT No.: PCT/CA2015/000325

§ 371 Date: Nov. 15, 2016

Related U.S. Application Data
(60) Provisional application No. 61/994,672, filed on May 16, 2014.

(51) Int. Cl. H05H 1/34

(52) U.S. Cl. CPC H05H 1/34; H05H 2001/3426; H05H 2001/3452; H05H 2001/3468

(57) ABSTRACT

An apparatus is disclosed wherein an electric arc is employed to heat an injected gas to a very high temperature. The apparatus comprises four internal components: a button cathode and three cylindrical co-axial components, a first short pilot insert, a second long insert and an anode. Vortex generators are located between these components for generating a vortex flow in the gas injected in the apparatus and which is to be heated at very high temperature by the electric arc struck between the anode and cathode. Cooling is provided to prevent melting of three of the internal components, i.e. the cathode, the anode and the pilot insert. However, to limit the heat loss to the cooling fluid, the long insert is made of an insulating material. In this way, more electrical energy is transferred to the gas.

### CROSS REFERENCE TO RELATED APPLICATIONS

This Application claims priority on U.S. Provisional Application No. 61/994,672, now pending, filed on May 16, 2014, which is herein incorporated by reference.

### FIELD

The present subject-matter relates to energy-efficient high power plasma torches.

### INTRODUCTION

Arc plasma torches are often used as gas heaters. The electric power fed to a torch is proportional to both the electrical current and to the voltage across the torch terminals; the amount of heat transferred from the torch electric arc, by contact with the injected gas to be heated, depends on the torch efficiency. The arc temperature being very high, in the 10 000 degree Celsius, the torch electrodes have to be water-cooled. This water-cooling result also in a transfer of heat from the arc to the cooling water; thus, the heat transferred to the injected gas, exiting the torch, is lower than the electrical energy provided by the electrical power supply.

The energy lost will depend, in particular, on the length of the water-cooled electrodes. In order to maximize the efficiency of transfer of heat to the exiting gas, it would, therefore, be of interest to have the electrodes as short as possible. However, in this case, the arc voltage, which is proportional to the arc length, will be small. To obtain the required power, the electrical current would have to be increased, resulting in increased electrode erosion and corresponding maintenance cost higher than with long electrode torches of equal power operating at lower current and high arc voltage.

For high power arc plasma gas heater torches, the choice of operation is therefore between:
High current with high energy transfer efficiency but high maintenance costs, or
High voltage with low maintenance costs but high heat loss to the cooling water.

The various torch proposals, which have appeared in the literature and/or have been commercialized, in the past 50 years, can be classified in one of these two categories:
To stretch the arc in order to obtain high voltage, as reported by Ramakrishnan, Camacho, Mogensen, Eschenbach and Hanus, several companies such as Tioxide, SKF and Acurex have proposed a multi electrode design and ways to force the arc attachment to move over from one segment to the other until the required high voltage is obtained. A torch of this general type is also illustrated, for example, in U.S. Pat. No. 4,543,470.
Others, as illustrated for example in U.S. Pat. No. 5,132,511 or as reported by Camacho, for devices marketed, for examples, by Westinghouse, SKF and Aerospatiale, have chosen to use a magnetic field to force the high current arc attachment foot to move rapidly on the electrode surface in an attempt to limit the electrode erosion resulting from their choice of operation at high current.

Therefore, there is a need for a high power plasma torch that is energy efficient.

### SUMMARY

It would thus be highly desirable to be provided with a novel plasma torch.

The embodiments described herein provide in one aspect a gas heater plasma torch adapted for operating in the non-transferred arc mode, characterized by a high transfer efficiency of heat to the injected gas, and comprising:
a cylindrical torch body,
a cylindrical rear electrode mounted coaxially within the torch body,
a short pilot tubular electrode bored through, mounted coaxially with and in front of the rear electrode,
a long tubular insert bored through, mounted coaxially with and in front of the short pilot electrode,
a short front electrode bored through, mounted coaxially with and in front of the long tubular insert,
a cylindrical tubular housing mounted between both the electrodes and the long tubular insert and the cylindrical torch body to provide sealed passages for a fluid coolant circulated through said passages to remove heat from the electrodes and the long tubular insert during operation of the torch,
first vortex generator provided between the rear electrode and the pilot electrode for generating a vortex flow of the appropriate gas in the chamber between the rear and pilot electrodes,
second vortex generator provided between the pilot electrode and the long tubular insert for generating a vortex flow of the appropriate gas in the long tubular insert,
third vortex generator provided between the long tubular insert and the short front electrode for generating a vortex flow of the appropriate gas in the short front electrode,
power supply means connected between the rear and the front electrodes for sustaining an arc through the flow of gas provided by the vortex generators,
means to ignite an arc discharge between the rear electrode and the pilot electrode, said arc being elongated in the long tubular insert far enough to reach the front electrode,
means for coordinating the arc parameters of electrical current and voltage with the gas flows provided by the vortex generators in such way that the arc attachment point on the surface of the pilot electrode and on the front electrode move rapidly on the said electrode surfaces in a circular motion as to distribute evenly the erosion of metal from the electrode thereby extending the torch life.

Also, the embodiments described herein provide in another aspect a gas heater plasma torch, comprising:
a torch body,
a tubular rear electrode mounted within the torch body,
a pilot tubular electrode, mounted in front of the rear electrode,
a tubular insert, mounted in front of the pilot electrode,
a front electrode, mounted in front of the tubular insert,
a housing mounted between both the electrodes and the tubular insert and the torch body to provide passages for a fluid coolant circulated through said passages,
a first feeding system for providing the appropriate gas in a chamber between the rear electrode and the pilot electrode,
a second feeding system for providing the appropriate gas in the tubular insert,
a third feeding system for providing the appropriate gas in the front electrode,
a power supply for sustaining an arc through the flow of gas provided by the feeding systems,
an ignition system to ignite an arc discharge between the rear electrode and the pilot electrode, said arc being elongated in the tubular insert so as to reach the front electrode,
a coordination system for coordinating the arc parameters of electrical current and voltage with the gas flows provided by the feeding systems.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 is a cross-sectional side view of a plasma torch in accordance with an exemplary embodiment, wherein a pilot arc between a button cathode and a pilot insert is illustrated as well as a hot plasma gas channeled in a long tubular insert;

FIG. 2 is another cross-sectional side view of the plasma torch, showing a main arc between the button cathode and an anode;

FIG. 3 is a schematic illustration of an electrical arrangement, and a cross-sectional side view of the plasma torch, in accordance with an exemplary embodiment, which allows the operation of the torch in energizing the pilot arc by closing first and second switches; upon transfer of the arc to the anode, such as illustrated in FIG. 2, the second switch may be opened;

FIG. 4 is a schematic partial sectional view of the relevant parts of a first embodiment of the long tubular insert in accordance with an exemplary embodiment;

FIG. 5 is a schematic partial sectional view of the relevant parts of a second embodiment of the long tubular insert in accordance with an exemplary embodiment; and

FIG. 6 is a schematic partial sectional view of the relevant parts of a third embodiment of the long tubular insert in accordance with an exemplary embodiment.

### DESCRIPTION OF VARIOUS EMBODIMENTS

The present apparatus is intended to address at least some of the disadvantages, discussed above, of previous gas heaters, mainly, to have to choose between an energy efficient torch, operating at high current, with very high maintenance costs and a torch, operating at high voltage, with low maintenance costs but very poor energy efficiency.

Thus, by means of the present apparatus, it is possible for a high power arc plasma gas heater torch, operating at low current and high voltage with a long arc, to have both high energy transfer efficiency to the gas and low maintenance costs.

To this effect, an energy-efficient high power plasma torch of the type comprising:

a) a button cathode, for instance made of copper and water cooled and equipped with an insert made of Tungsten or Tungsten doped with, for example, Thorium, Zircon or Lanthanum, to emit the electrons required for the arc or equipped with an Hafnium insert to avoid having to operate with an inert pilot gas as it would be the case with the Tungsten or Tungsten doped insert,

b) a short tubular pilot insert, for instance made of copper and water cooled and mounted coaxially with the button cathode and used as a temporary anode for the pilot arc established following breakdown between the cathode and the pilot insert,

c) a long tubular insert, for instance made of an electrically and thermally insulating material and mounted coaxially with both the cathode and the pilot insert and used, at first, to channel the hot plasma gas generated by the pilot arc established between the cathode and the pilot insert, and, in operation, to lengthen the arc to obtain the required arc voltage,

d) a short tubular electrode, for instance made of copper and water cooled and mounted coaxially with the cathode, pilot insert and long insert assembly and used as the anode for the main arc established between the button cathode and that electrode, following the voltage breakdown in the hot plasma gas generated by the pilot discharge between the cathode and the pilot insert and channeled by the long tubular insert,

can be operated at high voltage and low current with a high energy efficiency of transfer of energy to the gas as the use of an arc extender comprising an insulating material limits greatly the heat loss to the cooling water.

Therefore, a plasma torch T such as illustrated in the drawings, adapted only for operation in the non-transfer mode, embodies the features of the present exemplary embodiment. The torch T comprises an outer body (not shown) for instance made of metal such as stainless steel, in which the four components shown in the drawings, namely a cathode 10, a pilot insert 12, a long tubular insert 15 and an anode 16, are enclosed.

The cathode 10 is of the button type, for instance made of copper and water cooled and it is equipped with an insert 11, for instance made of Tungsten or of Tungsten doped with, for example, Thorium, Zircon or Lanthanum to emit the electrons required for the arc, or equipped with an Hafnium insert to avoid having to operate with an inert pilot gas as it would be the case with the Tungsten or Tungsten doped insert.

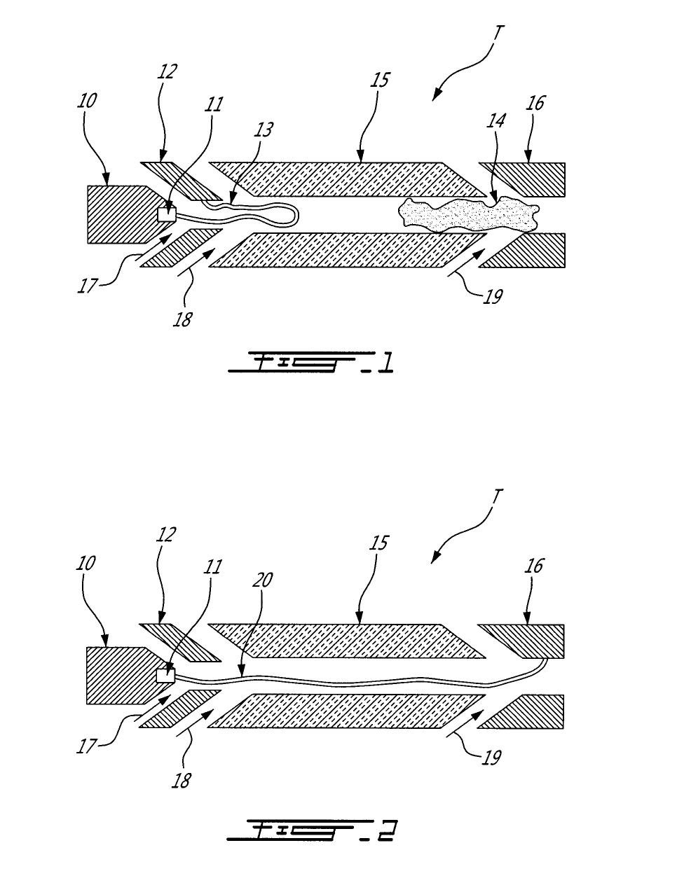

As illustrated in FIG. 1, the pilot insert 12, also for instance made of copper and water cooled, is mounted coaxially with the cathode 10. The pilot insert 12 is used, during start-up, as a temporary anode for a pilot arc 13 established following electrical breakdown between the cathode 10 and the pilot insert 12.

Also, as illustrated in FIG. 1, the long tubular insert 15, for instance made of an electrically and thermally insulating material and mounted coaxially with both the cathode 10 and the pilot insert 12, is used, during start-up, to channel hot plasma gas 14 generated by the pilot arc 13 established between the cathode 10 and the pilot insert 12. The length of the long tubular insert 15 depends, at least in part, on the desired operating voltage and arc length.

FIG. 2 illustrates the normal torch operation with a main arc 20 established between the cathode 10 and the downstream anode 16. The long insert 15 is now used to bring into contact with the arc 20, the gases 17 and 18, injected into the torch T by vortex generators (not shown) located between the cathode 10 and the pilot insert 12 and between the pilot insert 12 and the long insert 15, respectively. Additional gas 19 is injected by a third vortex generator (not shown) located between the long insert 15 and the anode 16.

The gas 19 is injected tangentially with respect to the anode surface, primarily, in order to force the arc attachment point to move rapidly on the anode surface in a circular motion as to distribute evenly the erosion of metal from the electrode to extend the torch operation length of time between required maintenance. A magnetic coil or a permanent magnet can also be provided around the anode 16 in order to apply an electromagnetic force on the arc to move the arc attachment point even faster on the anode surface and thus to reduce the electrode erosion even more.

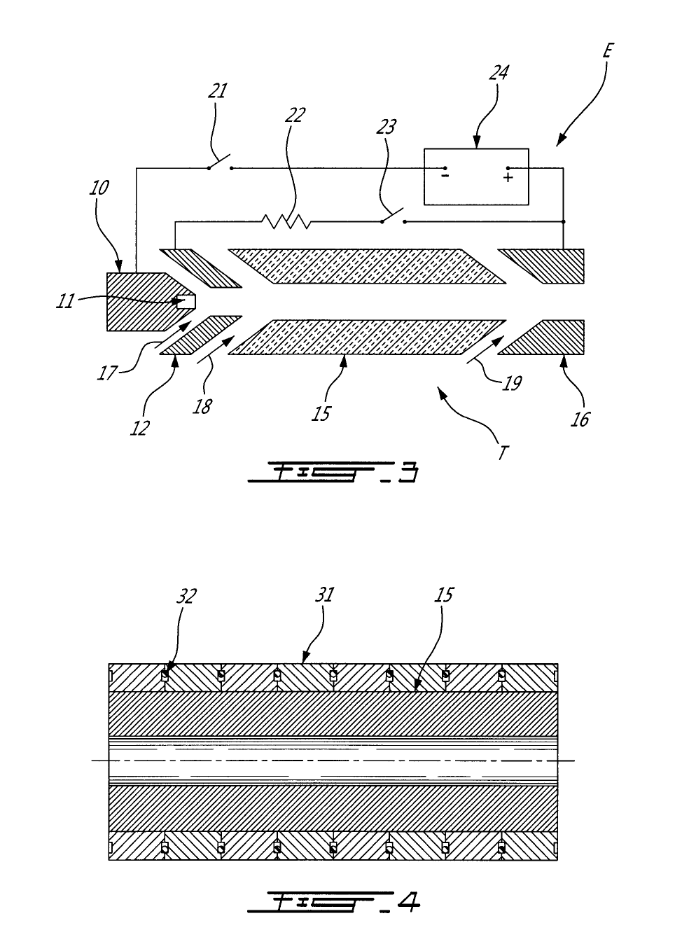

An electrical arrangement E is illustrated in FIG. 3. To proceed with the start-up, first and second switches 21 and 23 are both closed and a DC power supply 24 is turned on. An ignition module (not shown), connected between the cathode 10 and the pilot insert 12, is used to ionize the pilot gas between the cathode and the pilot insert resulting in the establishment of the pilot arc 13 which, as shown in FIG. 3, is supported by the DC power supply 24.

As shown in FIG. 1, the pilot arc 13, driven by the vortex flows 17 and 18, generated by gas vortex generators (not shown), extends somewhat in the tubular passage of the long insert 15. In addition, ionized gases produced by the pilot arc 13 lower considerably the electrical resistance path between the anode 16 and the downstream extension of the pilot arc 13. A resistor 22 is used to further increase the voltage difference between the anode 16 and the pilot insert 12. Because of this higher voltage potential of anode 16, an electrical breakdown between the extended arc 13 and the anode 16 should occur well before the arc 13 has reached the anode 16. Upon initiation of the main arc 20, the second switch 23 is disengaged.

As illustrated in FIGS. 1, 2 and 3, the internal diameter of the pilot insert 12 is smaller than that of the long tubular insert 15. It has been found, during tests, that the ratio between the diameter of the pilot insert 12, d1, and that of the long tubular insert 15, d2, affects the arc stability; in one embodiment, preliminary tests have used, for a power up to 400 kW, a ratio of d2/d1 in the 1.15 to 1.35 range.

In FIGS. 4, 5 and 6, there are shown further embodiments of the apparatus in accordance with exemplary embodiments, whereby only the most relevant parts of the long tubular insert are shown. In each of these embodiments, the long tubular insert, for instance made of mostly insulating material, is contained into a tubular arrangement made mostly of metal which is water cooled.

In the embodiment of FIG. 4, the internal insert 15 is made of one piece inserted in a tubular arrangement that includes metal rings 31 sealed and insulated from one another by sealing rings 32.

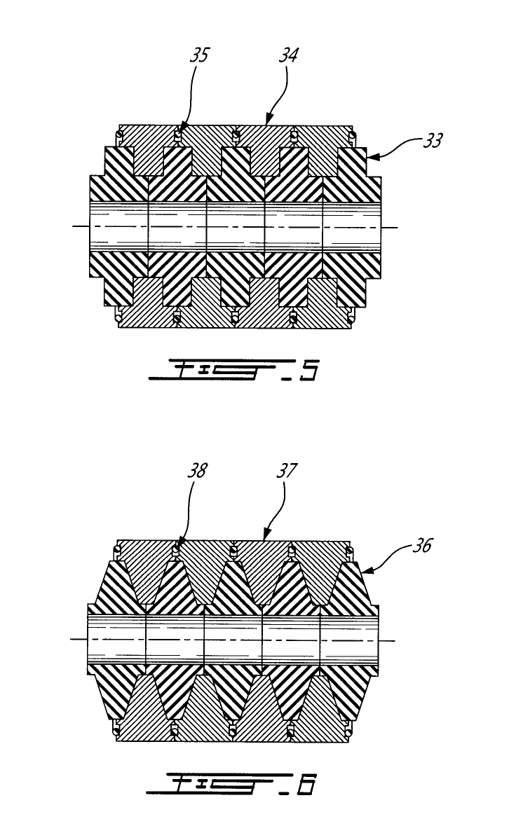

In the embodiment of FIG. 5, the internal insert includes rings 33 of insulating material, separated by metal rings 34 which are, themselves, sealed and insulated from one another by sealing rings 35.

In the embodiment of FIG. 6, the internal insert also includes rings 36 of insulating material, different in cross section from those shown in FIG. 5. The rings 36 are separated by metal rings 37 which are, themselves, sealed and insulated from one another by sealing rings 38.

In FIGS. 5 and 6, the number of rings of insulating material 33 and 36 respectively, will depend, at least in part, on the desired operating voltage and arc length.

The long tubular insert comprising either a single long tube 15 (as shown in FIGS. 1 to 4) or of a number of rings 33 and 36 (as shown in FIGS. 5 and 6, respectively) is for instance made of a material having a good electrical resistivity and low thermal conductivity and simultaneously having a very high melting temperature such as, for example, Silicon Carbide or Hexoloy manufactured by Saint-Gobain Ceramics, or Boron Nitride also manufactured by Saint-Gobain and by ESK. Silicon Carbide, Hexoloy and Boron Nitride are considered, for example, because their thermal conductivity being about five times lower than copper, the heat loss from the hot plasma channeled into the long insert between the cathode and the anode will be only about 20% of what it would be with copper.

Although not shown in the drawings, the long tubular insert that includes either a single long tube 15, as shown in FIGS. 1, 2, 3 and 4, or of a number of rings 33 and 36, as shown respectively in FIGS. 5 and 6, is provided with orifices in the wall(s) thereof, at different locations, to inject a gas tangentially. The resulting vortex gas flows increase the heat transfer from the arc to the surrounding gas and in that way increase the voltage required to sustain the arc. These additional vortex flows, in the long tubular insert, not only cool the insert bore surface but also stabilize the arc and allow increasing the insert bore diameter, wall stabilization being less required.

The exemplary embodiment is further illustrated by the following example:

### EXAMPLE

For comparison, tests were conducted with a plasma torch equipped with either a long tubular copper anode or with the insulating insert as described in relation with FIG. 1.

In both case the power was 400 kW at 800 Amperes and 500 Volts. Air flow was 920 liters per minute. The cathode and nozzle water cooling circuit was independent from the anode water cooling circuit in order to be able to make separate measurements of the heat loss of these torch components.

Water flows to the cathode and the anode were 45 liters per minute and 40 liters per minute, respectively. The cathode water temperature increase was 8° C. in both cases indicating a heat transfer to the cooling water of 25 kW.

With the long tubular copper anode the water temperature increase was 25° C. corresponding to a heat transfer to the cooling water of 69.7 kW.

When equipped with the insulating insert the anode temperature increase was only 5° C. corresponding to a heat transfer of 14 kW.

The corresponding torch efficiencies were 76% for the torch equipped with a regular copper anode and 90% for the torch equipped with the insulating insert, therefore an increase of 14% in efficiency.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

### REFERENCES

### US Patent Documents:

| | | |
|---|---|---|
| 4,543,470 | September 1985 | Santen, et al |
| 5,132,511 | June 1992 | Labrot, et al |

### Other Publications:

Ramakrishnan, et al, Technological Challenges in Thermal Plasma, CSIRO Publishing www.publish.csiro.au/?act=view_file&file_id=PH950377
Camacho, Industrial-worthy plasma torches State-of-the-art, Pure & Appl. Chem., Vol. 60, No. 5, pp. 619-632, 1988.
Mogensen, et al, Electrical and Mechanical Technology of Plasma Generation and Control, in Plasma Technology in Metallurgical Processing by J. Feinman, The Iron and Steel Society, 1987, pp. 65-76
Eschenbach, et al, Plasma Torches and Plasma torch Furnaces, in Plasma Technology in Metallurgical Processing by J. Feinman, The Iron and Steel Society, 1987, pp. 77-87.
Hanus, Phoenix Solutions' Plasma Arc Application and High-Temperature Process Experience, Proceedings Plasma Arc Technology, Oct. 29-30, 1996, pp. 321-352.

1. A gas heater plasma torch adapted for operating in the non-transferred arc mode, characterized by a high transfer efficiency of heat to the injected gas, and comprising:
a cylindrical torch body,
a cylindrical rear electrode mounted coaxially within the torch body,
a short pilot tubular electrode bored through, mounted coaxially with and in front of the rear electrode,
a long tubular insert bored through, mounted coaxially with and in front of the short pilot electrode,
a short front electrode bored through, mounted coaxially with and in front of the long tubular insert,
a cylindrical tubular housing mounted between both the electrodes and the long tubular insert and the cylindrical torch body to provide sealed passages for a fluid coolant circulated through said passages to remove heat from the electrodes and the long tubular insert during operation of the torch,
first vortex generator provided between the rear electrode and the pilot electrode for generating a vortex flow of the appropriate gas in the chamber between the rear and pilot electrodes,
second vortex generator provided between the pilot electrode and the long tubular insert for generating a vortex flow of the appropriate gas in the long tubular insert,
third vortex generator provided between the long tubular insert and the short front electrode for generating a vortex flow of the appropriate gas in the short front electrode,
power supply means connected between the rear and the front electrodes for sustaining an arc through the flow of gas provided by the vortex generators,
means to ignite an arc discharge between the rear electrode and the pilot electrode, said arc being elongated in the long tubular insert far enough to reach the front electrode,
means for coordinating the arc parameters of electrical current and voltage with the gas flows provided by the vortex generators in such way that the arc attachment point on the surface of the pilot electrode and on the front electrode move rapidly on the said electrode surfaces in a circular motion as to distribute evenly the erosion of metal from the electrode thereby extending the torch life.

2. The gas heater plasma torch according to claim 1, wherein the long tubular insert has a greater diameter than the short pilot electrode.

3. The gas heater plasma torch according to claim 1, wherein the long tubular insert is made of an insulating material.

4. The gas heater plasma torch according to claim 1, wherein the long tubular insert includes a plurality of annular rings made of insulating material separated by metal rings.

5. The gas heater plasma torch according to any one of claims 1 and 3, wherein the long tubular insert includes a plurality of annular rings made of insulating material separated by metal rings in which the metal rings are separated by a seal which also provides electrical insulation between the rings.

6. The gas heater plasma torch according to claim 1, wherein the rear electrode is provided with a Tungsten insert or a Tungsten doped with, for example, Thorium, Zircon or Lanthanum, to emit electrons.

7. The gas heater plasma torch according to claim 1, wherein the rear electrode is provided with a Hafnium insert to emit electrons.

8. The gas heater plasma torch according to claim 1, wherein the rear electrode, the pilot electrode and the front electrode are made of copper.

9. The gas heater plasma torch according to claim 1, wherein the long tubular insert insulating material is made of Silicon Carbide.

10. The gas heater plasma torch according to claim 1, wherein the long tubular insert insulating material is made of Hexoloy Silicon Carbide.

11. The gas heater plasma torch according to claim 1, wherein the long tubular insert insulating material is made of Boron Nitride.

12. The gas heater plasma torch according to any one of claims 4 and 5, wherein the annular rings of insulating material are made of Silicon Carbide.

13. The gas heater plasma torch according to any one of claims 4 and 5, wherein the annular rings of insulating material are made of Hexoloy Silicon Carbide.

14. The gas heater plasma torch according to any one of claims 4 and 5, wherein the annular rings of insulating material are made of Boron Nitride.

15. The gas heater plasma torch according to any one of claims 1 and 3, wherein orifices are provided in the tubular insert at various locations, to inject a gas tangentially in a vortex flow around the arc column.

16. The gas heater plasma torch according to any one of claims 4 and 5, wherein orifices are provided in the annular rings at various locations, to inject a gas tangentially in a vortex flow around the arc column.

17. The gas heater plasma torch according to claim 1, wherein a magnetic coil or a permanent magnet is provided around the front electrode to force the arc attachment point to move rapidly on the said electrode surface in a circular motion as to distribute evenly the erosion of metal from the electrode thereby extending the torch life.

18. A gas heater plasma torch, comprising:
a torch body,
a tubular rear electrode mounted within the torch body,
a pilot tubular electrode, mounted in front of the rear electrode,
a tubular insert, mounted in front of the pilot electrode,
a front electrode, mounted in front of the tubular insert,
a housing mounted between both the electrodes and the tubular insert and the torch body to provide passages for a fluid coolant circulated through said passages,
a first feeding system for providing the appropriate gas in a chamber between the rear electrode and the pilot electrode,
a second feeding system for providing the appropriate gas in the tubular insert,
a third feeding system for providing the appropriate gas in the front electrode,
a power supply for sustaining an arc through the flow of gas provided by the feeding systems,
an ignition system to ignite an arc discharge between the rear electrode and the pilot electrode, said arc being elongated in the tubular insert so as to reach the front electrode,
a coordination system for coordinating the arc parameters of electrical current and voltage with the gas flows provided by the feeding systems.

19. The gas heater plasma torch according to claim 18, wherein the tubular insert is substantially long.

20. The gas heater plasma torch according to any one of claims 18 and 19, wherein the pilot electrode is substantially short.

21. The gas heater plasma torch according to any one of claims 18 to 20, wherein the front electrode is substantially short.

22. The gas heater plasma torch according to any one of claims 18 to 21, wherein the tubular insert has a greater diameter than the pilot electrode.

23. The gas heater plasma torch according to any one of claims 18 to 22, wherein at least one of the rear electrode, the pilot electrode, the tubular insert and the front electrode is substantially cylindrical.

24. The gas heater plasma torch according to any one of claims 18 to 23, wherein the housing is substantially cylindrical.

25. The gas heater plasma torch according to any one of claims 18 to 24, wherein the rear electrode is mounted substantially coaxially within the torch body.

26. The gas heater plasma torch according to any one of claims 18 to 25, wherein the pilot electrode is mounted coaxially with and in front of the rear electrode.

27. The gas heater plasma torch according to any one of claims 18 to 26, wherein the tubular insert is mounted coaxially with and in front of the pilot electrode.

28. The gas heater plasma torch according to any one of claims 18 to 27, wherein the front electrode is mounted coaxially with and in front of the tubular insert.

29. The gas heater plasma torch according to any one of claims 18 to 28, wherein the rear electrode, the pilot electrode, the tubular insert and the front electrode are substantially cylindrical.

30. The gas heater plasma torch according to any one of claims 18 to 29, wherein the torch body is substantially cylindrical.

31. The gas heater plasma torch according to any one of claims 18 to 30, wherein the passages for the fluid coolant are sealed.

32. The gas heater plasma torch according to any one of claims 18 to 31, wherein the fluid coolant circulating through said passages is adapted to remove heat from the electrodes and the tubular insert during operation of the torch.

33. The gas heater plasma torch according to any one of claims 18 to 32, wherein the first, second and third feeding systems include respectively first, second and third vortex generators.

34. The gas heater plasma torch according to any one of claims 18 to 33, wherein the first vortex generator is provided between the rear electrode and the pilot electrode for generating a vortex flow of the appropriate gas in the chamber between the rear and pilot electrodes.

35. The gas heater plasma torch according to any one of claims 18 to 33, wherein the second vortex generator is provided between the pilot electrode and the tubular insert for generating a vortex flow of the appropriate gas in the tubular insert.

36. The gas heater plasma torch according to any one of claims 18 to 33, wherein the third vortex generator is provided between the tubular insert and the front electrode for generating a vortex flow of the appropriate gas in the front electrode.

37. The gas heater plasma torch according to any one of claims 18 to 36, wherein the power supply means is connected between the rear and the front electrodes for sustaining the arc through the flow of gas provided by the feeding systems or vortex generators.

38. The gas heater plasma torch according to any one of claims 18 to 37, wherein the coordination system is adapted to coordinate the arc parameters of electrical current and voltage with the gas flows provided by the feeding systems or vortex generators in such way that the arc attachment point on the surface of the pilot electrode and on the front electrode move rapidly on the said electrode surfaces in a circular motion as to distribute substantially evenly the erosion of metal from the electrode thereby extending the torch life.

39. The gas heater plasma torch according to any one of claims 18 to 38, wherein the tubular insert is made of an insulating material.

40. The gas heater plasma torch according to any one of claims 18 to 39, wherein the tubular insert includes a plurality of annular rings made of insulating material, which are separated by metal rings.

41. The gas heater plasma torch according to any one of claims 18 to 39, wherein the tubular insert includes a plurality of annular rings made of insulating material, which are separated by metal rings in which the metal rings are separated by seals which also provide electrical insulation between the rings.

42. The gas heater plasma torch according to any one of claims 18 to 41, wherein the rear electrode is provided with a Tungsten insert or a Tungsten doped with, for example, Thorium, Zircon or Lanthanum, to emit electrons.

43. The gas heater plasma torch according to any one of claims 18 to 41, wherein the rear electrode is provided with a Hafnium insert to emit electrons.

44. The gas heater plasma torch according to any one of claims 18 to 41, wherein the rear electrode, the pilot electrode and the front electrode are made of copper.

45. The gas heater plasma torch according to any one of claims 18 to 41, wherein the tubular insert insulating material is made of Silicon Carbide.

46. The gas heater plasma torch according to any one of claims 18 to 41, wherein the tubular insert insulating material is made of Hexoloy Silicon Carbide.

47. The gas heater plasma torch according to any one of claims 18 to 41, wherein the long tubular insert insulating material is made of Boron Nitride.

48. The gas heater plasma torch according to any one of claims 40 and 41, wherein the annular rings of insulating material are made of Silicon Carbide.

49. The gas heater plasma torch according to any one of claims 40 and 41, wherein the annular rings of insulating material are made of Hexoloy Silicon Carbide.

50. The gas heater plasma torch according to any one of claims 40 and 41, wherein the annular rings of insulating material are made of Boron Nitride.

51. The gas heater plasma torch according to any one of claims 18 to 50, wherein orifices are provided in the tubular insert at various locations, to inject a gas tangentially in a vortex flow around the arc column.

52. The gas heater plasma torch according to any one of claims 40 and 41, wherein orifices are provided in the annular rings at various locations, to inject a gas tangentially in a vortex flow around the arc column.

53. The gas heater plasma torch according to any one of claims 18 to 52, wherein a magnetic coil or a permanent magnet is provided around the front electrode to force the arc attachment point to move rapidly on the said electrode surface in a circular motion as to distribute evenly the erosion of metal from the electrode thereby extending the torch life.

54. The gas heater plasma torch according to any one of claims 18 to 53, wherein the gas heater plasma torch is adapted for operating in the non-transferred arc mode.
